(19) United States
(12) Patent Application Publication
(10) Pub. No.: US 2013/0198029 A1
(43) Pub. Date: Aug. 1, 2013

(54) APPLICATION RECOMMENDATION AND SUBSTITUTION

(71) Applicants: David Mowatt, Dublin (IE); Terry Farrell, Dublin (IE); Norbert van Woerkom, Dublin (IE)

(72) Inventors: David Mowatt, Dublin (IE); Terry Farrell, Dublin (IE); Norbert van Woerkom, Dublin (IE)

(73) Assignee: Microsoft Corporation, Redmond, WA (US)

(21) Appl. No.: 13/358,950

(22) Filed: Jan. 26, 2012

(51) Int. Cl. G06Q 30/00

(52) U.S. Cl. 705/26.7

(57) ABSTRACT

Methods and systems for application recommendation and substitution are provided herein. The method includes analyzing data within a platform of a computing device to determine a pattern of the data. The method also includes acquiring a list of applications from a marketplace service, wherein the applications are compatible with the pattern of the data. The method further includes activating an application within the platform, wherein the application is selected in response to an input by a user from the list of applications.

### BACKGROUND

Users of computing devices often desire to perform operations using a number of different types of data. However, it may be difficult to locate an application which is capable of manipulating or consuming a particular type of data. Thus, users may often be forced to browse through large catalogs of applications. As a result, users may consume a large amount of time trying to identify an acceptable application that is compatible with the particular type of data.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for application recommendation and substitution. The method includes analyzing data within a platform of a computing device to determine a pattern of the data. The method also includes acquiring a list of applications from a marketplace service, wherein the applications are compatible with the pattern of the data. The method further includes activating an application within the platform, wherein the application is selected in response to an input by a user from the list of applications.

Another embodiment provides a system for application recommendation and substitution. The system includes a computing device configured to determine, within a platform of the computing device, a type of data being used by a user. The computing device is also configured to acquire a list of applications that are compatible with the type of the data being used by the user and initiate an application within the platform, wherein the application is selected from the list of applications in response to an input by the user.

Another embodiment provides one or more non-transitory, computer-readable storage media for storing computer-readable instructions. The computer-readable instructions provide an application recommendation and substitution system when executed by one or more processing devices. The computer-readable instructions include code configured to analyze data to determine one or more data contracts relating to the data and compile a list of applications including applications that are compatible with the one or more data contracts. The computer-readable instructions also include code configured to initiate an application in response to an input from a user and insert the data, as well as configuration data relating to the data, into the application.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a computing system that may be used to implement an application recommendation and substitution procedure;

FIG. 2 is a schematic of a computing environment in which an application recommendation and substitution procedure may be performed;

FIG. 3 is a process flow diagram showing a method for substituting an application for a previously-active application;

FIG. 4 is a process flow diagram showing a method for recommending an application to a user;

FIG. 5 is a process flow diagram showing a method for application recommendation and substitution; and

FIG. 6 is a block diagram showing a tangible, non-transitory computer-readable medium that stores code adapted to implement an application recommendation and substitution procedure.

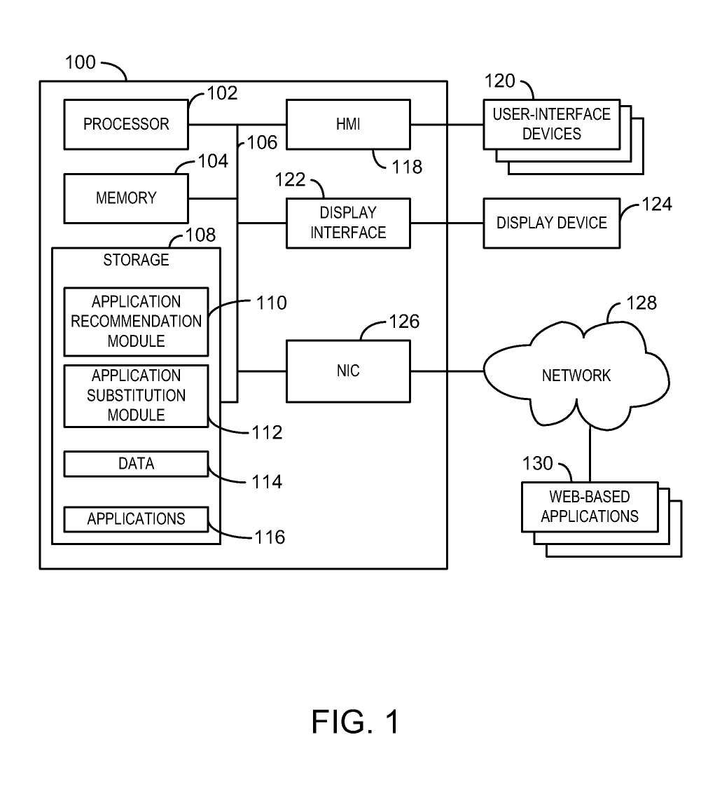

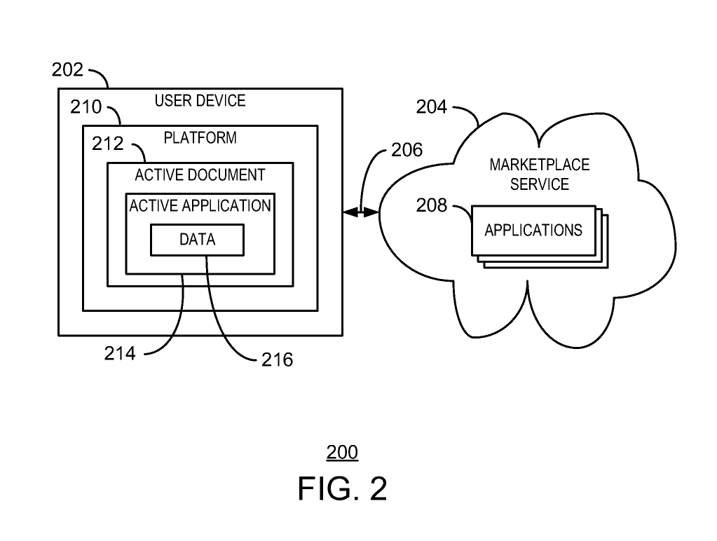

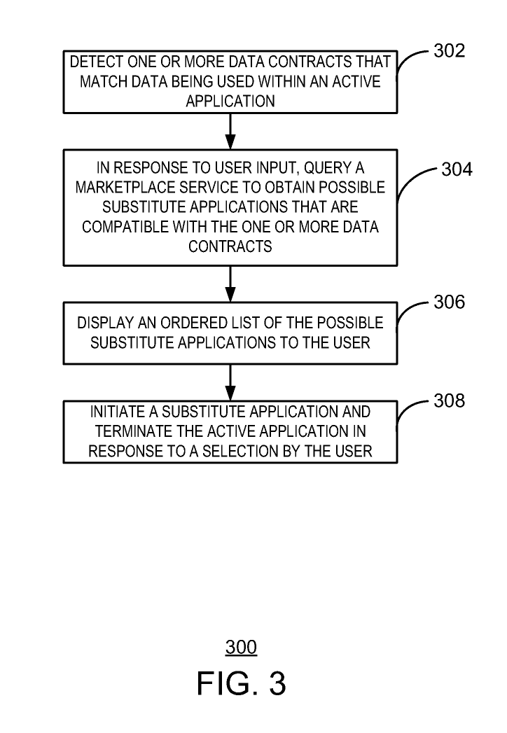

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

Embodiments disclosed herein set forth a method and system for application recommendation and substitution. Specific data that is hosted within a platform of a computing device may be analyzed to determine the pattern of the data, e.g., a data contract relating to the data. For example, in some embodiments, such analysis may result in the identification of specific data as a selection of text inside a document that is open in MICROSOFT WORD, available from Microsoft Corporation of Redmond, Wash. According to embodiments disclosed herein, the pattern of the data is the specific characteristics of the data or, equivalently, the type of the data, e.g., textual data, image data, or audio data, among others.

The specific data that is analyzed may include a portion of data that is selected by a user within a document, or data that is hosted within an active application. Once the pattern of the data has been determined within the platform, the platform may query a marketplace service to acquire a list of applications that are compatible with the same type of data. For example, if it is determined that the data includes text relating to terms and definitions, the list of applications may include a dictionary application and a thesaurus application, among others. As used herein, the term “application” refers to any type of application or service that is capable of utilizing specific types of data within a computing environment. This process may be initiated in response to a user input, which indicates that a user is unsatisfied with the active application, or that the user wishes to determine an acceptable application to use in conjunction with the specific data. The list of applications obtained from the marketplace service may be displayed to the user via the platform, and the user may select a desired application. The selected application may then be activated within the platform, and the specific data may be viewed or manipulated by the user via the newly-active application.

As a preliminary matter, some of the figures describe concepts in the context of one or more structural components, variously referred to as functionality, modules, features, elements, etc. The various components shown in the figures can be implemented in any manner, for example, by software, hardware (e.g., discreet logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discreet logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory, computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

FIG. 1 is a block diagram of a computing system 100 that may be used to implement an application recommendation and substitution procedure. The computing system 100 may be included within a computing device, such as, for example, a mobile phone, a tablet, a desktop computer, a laptop computer, an electronic reader, a television, or a media player, or any combinations thereof. The computing system 100 may include a processor 102 that is adapted to execute stored instructions, as well as a memory device 104 that stores instructions that are executable by the processor 102. The processor 102 may be a single core processor, a multi-core processor, a computing cluster, or any number of other configurations. The memory device 104 can include random access memory (RAM), read only memory (ROM), flash memory, or any other suitable memory systems. The stored instructions executed by the processor 102 may implement a method for recommending an application to be used with a specific type of data, or substituting an application for a previously-active application that is capable of using the same type of data. The processor 102 may be connected through a bus 106 to one or more input and output devices.

The computing system 100 may include a storage device 108 adapted to store an application recommendation module 110 and an application substitution module 112. The storage device 108 may include a hard drive, an optical drive, a thumbdrive, an array of drives, or any combinations thereof. Moreover, the storage device 108 may also be adapted to store data 114, as well as any number of applications 116. In some embodiments, the data 114 may be created within specific applications or programs, such as any of the applications 116. In addition, the applications 116 may be contained within documents that run within a platform of the computing system 100. Further, in some embodiments, the data 114 is contained within a document, and it may desirable to determine an application, such as any of the applications 116, to be used for manipulating the data 114.

A human-machine interface (HMI) 118 may connect the system 100 to any number of user-interface devices 120, such as a touchscreen, a speaker, or a pointing device, among others. The system 100 may be linked through the bus 106 to a display interface 122 adapted to connect the system 100 to a display device 124. The display device 124 may include a computer monitor or a display screen of a mobile device, among others.

A network interface controller (NIC) 126 may be included to connect the system 100 through the bus 106 to a network 128. Through the network 128, Web-based applications 130 may be downloaded and stored within the computer's storage device 108, or may be accessed through a Web browser. The Web-based applications 130 may be stored on a remote server or computing device. In various embodiments, the Web-based applications 130 may be downloaded from a marketplace service via the network 128. Further, in some embodiments, the applications 130 may be downloaded from any number of third party services via the network 128.

FIG. 2 is a schematic of a computing environment 200 in which an application recommendation and substitution procedure may be performed. The computing environment 200 may include a user device 202 that is communicably coupled to a marketplace service 204 through a network, as indicated by arrow 206. The network may be a local area network (LAN), a wide area network (WAN), a wireless wide area network (WWAN), or the Internet, among others. The user device 202 may be any type of computing device that is capable of implementing the application recommendation and substitution procedure, such as, for example, the computing system 100 described with respect to FIG. 1.

In various embodiments, the marketplace service 204 may include a number of servers, such as cloud servers, for example, that are configured to store a variety of applications 208 within an application center. The marketplace service 204 may provide any number of the applications 208 to the user device 202 in response to a query from a platform 210 within the user device 202, which may be initiated in response to an input from a user of the user device 202. In some embodiments, the user of the user device 202 may be requested to sign in to the marketplace service 204 or to pay a licensing fee for a particular application 208 before it is downloaded to the user device 202. The marketplace service 204 may also be configured to directly control access to services offered by each of the applications 208 within the application center. Further, in some embodiments, any number of the applications 208 may be downloaded directly from any number of third party services (not shown). The third party services may include services provided through the network using, for example, HTPP protocol, FTP protocol, or HTTPS protocol, or may be services provided using a custom non-HTTP protocol, such as a direct DCE/RPC call.

The platform 210 within the user device 202 may be configured to host a number of different types of applications, services, or programs. An active document 212 may be running within the platform 210. In various embodiments, an active application 214 that is opened within the active document 212 may include specific data 216 that is of interest to the user. In some embodiments, if the specific data 216 is hosted within the active application 214, the platform 210 may query the marketplace service 204 to determine a list of applications 208 that are compatible with the same types of data, or patterns of data, as the active application 214. In some embodiments, the user may specify additional constraints for determining which applications to include in the list of applications 208. For example, the user may desire to view only applications that are compatible with a certain language. In addition, the list of applications 208 may be narrowed down to only applications that support the platform 210. Once the user selects an application from the list of applications 208, the chosen application may be opened within the active document 212, and the specific data 216, as well as related configuration data, may be opened within the application.

Further, in various embodiments, the specific data 216 is hosted within the active document 212, but there is no active application 216. In such cases, the user may select at least some portion of the specific data 216 within the active document 212. Then, the platform 210 may query the marketplace service 204 to determine a list of applications 208 that are compatible with the specific data 216.

FIGS. 3, 4, and 5 are process flow diagrams showing methods for implementing the application recommendation and substitution procedure disclosed herein, as discussed below. The methods may be implemented within a platform of a user device, such as the computing system 100 described with respect to FIG. 1. Further, each application, or service, that may be utilized in conjunction with the methods may include a manifest. The manifest may contain standard information about the application, including the application's identifier, the application's name, the application's category, the languages that are supported by the application, and the one or more data contracts that are supported by the application. As used herein, the term “data contract” refers to a specification of the type(s) of data that a particular application supports or a type of file that includes the specification of the type(s) of data that the application supports, such as, for example, video objects, image files, text strings, multi-level bulleted lists, or tables, among others. A data contract may be used to specify a particular type of data or a particular pattern of data. In some embodiments, a data contract may also specify a maximum and/or minimum length, number of rows, or number of columns for the data. Further, a data contract may contain specific expressions indicating that the data includes coordinate points, dates, or zip codes, among others.

The data contracts specified by each of the applications may be part of a defined set of data contracts, or they may be created ad-hoc. For example, charting tools and font selectors may be represented by defined data contracts. The defined data contracts for charting tools may relate to tables of numeric data, while the defined data contracts for font selectors may relate to short amounts of text. In such cases, the data contract itself, which may contain expected input and configuration data, is defined in isolation and is given a specific identifier, or name. The use of a specific identifier may help to formalize the existence of the data contract, as well as incentivize sharing and reuse, and minimize the risk of multiple conflicting identifiers for different data contracts. The data contracts may be published in a file that is hosted within the marketplace service. In some embodiments, only the owner(s) of the marketplace service are able to publish defined data contracts. In other embodiments, any developer participating in the marketplace service is able to publish an ad-hoc data contract. Thus, the manifest of an application may contain either an ad-hoc data contract fully described in-line in the manifest, or a simple reference to a defined data contract, which was separately published to a known location within the marketplace service. Further, in some embodiments, the marketplace service allows applications that use defined data contracts but disallows applications that use ad-hoc data contracts.

In some embodiments, if a developer has several distinct applications that they wish to sell individually, e.g., several different photo manipulation applications, the developer may also include information in the manifest about the related identifiers for the applications that are interchangeable. Alternatively, if an application is embedded within a template, e.g., a data visualization template, then the information about related applications may be stored as metadata in the template rather than in the application's manifest.

Once a particular application has been developed and submitted to the marketplace service, the marketplace service may verify that the application functions properly. Specifically the marketplace service may ensure that the application is compatible with the data that is specified in the data contract(s) found within the application's manifest.

FIG. 3 is a process flow diagram showing a method 300 for substituting an application for a previously-active application. A user may locate a desired application via the marketplace service and then install the application into the environment in which it will be used. The environment may include a specific program within the platform of the user device. For example, a user may install a data visualization application into a spreadsheet program and select a range of cells that the application may use. The user may also highlight a data point in the visualization and annotate it with a comment.

At this point, the platform is aware of the product in which the application is being run in, the specific application that is being used, and the developer of the specific application. The platform is also aware of the data that is being used. For example, in some embodiments, a specific portion of data may be highlighted or selected. Further, the platform is aware of the information contained within the application's manifest, such as the data contract(s) with which the application is compatible and the application's category, among others.

The method begins at block 302 with the detection of one or more data contracts that match specific data being used within an application. In various embodiments, the platform applies each data contract against the specific data to determine one or more data contracts that relate to the data. In some embodiments, a number of data contracts may be listed in the manifest, and the platform may choose one or more data contracts based on their relevance to the data and the order in which they are listed in the manifest. For example, the data contracts may be ordered from the most restrictive data contract to the least restrictive data contract. Generally, data contracts that are more complex are more restrictive. In addition, in some embodiments, the data contracts are detectable parts of the metadata in the template. In such cases, the process of ordering, or matching, the one or more data contracts based on their relevance may be eliminated. Further, in some embodiments, the platform directly queries the active application to determine the data contract that the application is currently leveraging.

At this point in the method 300, the platform may be aware of the platform identifier, the application identifier, the author of the application, the category of the application, and the preferred language of the user. The platform may also be aware of the data contract identifier, the specific data being used within the application, and the configuration data for the application. In addition, the platform may be aware of other applications that the user has acquired, which can be used to help in the determination of which substitute applications the user will find valuable.

At block 304, the marketplace service may be queried to obtain possible substitute applications that are compatible with the one or more data contracts. This may occur in response to a user input, as described further below.

In various embodiments, the marketplace service stores the global usage information for each application. Thus, for the application that is currently in use, the marketplace service may be aware of the number of times the application has been downloaded, the average rating that the application has been given by users, the number of days that the application has been listed though the marketplace service, and the application's “boost” rating, e.g., the rating given to the application by the marketplace service, among others.

In addition, the marketplace service may be aware of the relationship between the current application and various other applications stored within the marketplace service. For example, the marketplace service may be aware of the number of times that a user viewed the current application's details page in the marketplace service but ultimately downloaded another application. The marketplace service may be aware of the number of times that a user who owns the current application downloaded any number of other applications. The marketplace service may also be aware of the number of times that a user who was using the current application switched to another application. Further, the marketplace service may be aware of the number of times that a user who was using the current application chose the current application over another application when given a choice between the two applications.

Thus, using the aforementioned information, the platform may query the marketplace service at block 304 to obtain a list of related applications that may be suitable substitutes for the current application. This may occur in response to a user input, such as, for example, a user right-clicking on the current application and choosing a “change application” option. In response to the user input, the marketplace service may be queried to obtain an unordered list of applications with one or more data contracts matching the data contract(s) of the current application. In addition, the list of applications may be restricted to applications that are compatible with the platform identifier of the current platform.

At block 306, an ordered list of the possible substitute applications may be displayed to the user. The sorting of the unordered list of applications to obtain the ordered list of applications may be accomplished through the computation of a ranking score for each application. The ranking score may be based on a number of characteristics, including, for example, a user rating for the application, a download count for the application, a freshness of the application, e.g., the amount of time the application has been available through the marketplace service, a health of the application, e.g., the number of times that the application has crashed, and a boost rating for the application. The ranking score may also be based on a category identifier match between the application and the current application, a switch count between the application and the current application, a skip count corresponding to not choosing an application to replace the current application; a mutual download count for the application and the current application, a developer identifier match between the application and the current application, and a number of configuration values in the application that match configuration values in the current application. In addition, the ranking score may be based on the relationship between a candidate substitute application and other applications that the user has already acquired.

Through standard statistical training methods, a weight is computed for each of the characteristics discussed above. In some embodiments, the weights for the characteristics may be tuned according to specific business needs. Then, a total score is generated for each application by summing the score for each characteristic multiplied by its weight. This total score may determine the order of a particular application within the list of possible substitute applications.

The ordered list of applications may be sent from the marketplace service to the platform, and may be displayed to the user. The list of application may be further segregated according to the specific desires of the user. For example, the user may view the full list of all possible substitute applications, or the user may view the list of possible substitute applications with the same developer identifier. Further, in some embodiments, recommended alternate applications that are listed within the manifest of the current application may be promoted to the top of the list.

In some embodiments, the platform may display a preview of a possible substitute application to the user via a preview mode. A preview of an application may be representative of the functionality and appearance of the specific data within the application. To support such a preview mode, the manifest for the application may contain a URL of externally hosted Web services that may be passed the input data and the configuration data by the platform and may return the expected output.

At block 308, a substitute application may be initiated and the active application may be terminated in response to a selection by the user. In various embodiments, the current application may share configuration data with the chosen substitute application. For example, the configuration data may be shared as namespaced variables and properties. In addition, z-order, size, positioning information, and other standard data may be shared between the applications to minimize the reconfiguration costs for initiating the substitute application. In some embodiments, if a particular substitute application does not know how to leverage the configuration data or other shared data, the application simply ignores the shared data.

The process flow diagram of FIG. 3 is not intended to indicate that the steps of the method 300 are to be executed in any particular order, or that all of the steps are to be included in every case. Further, any number of additional steps may be included within the method 300, depending on the specific application. For example, the application identifiers and configuration data for the previously-active application may be saved, and the platform may undo the installation of the substitute application and revert to the previously-active application.

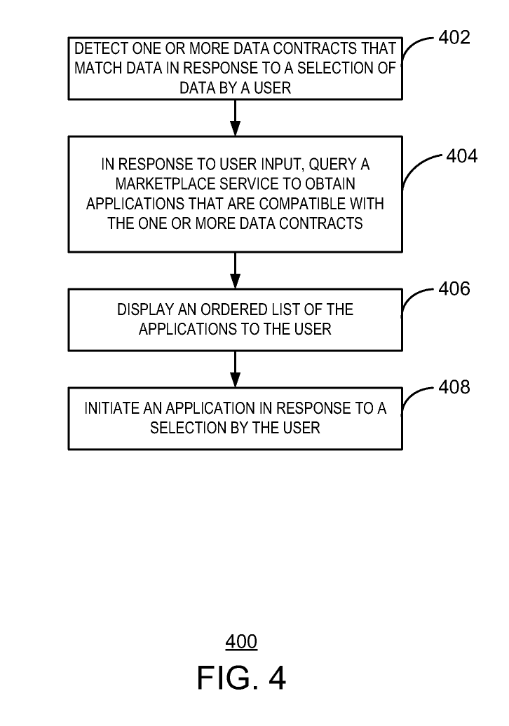

FIG. 4 is a process flow diagram showing a method 400 for recommending an application to a user. The method 400 begins at block 402 with the detection of one or more data contracts that match specific data in response to a selection of data by a user. For example, the user may select specific data within a particular document or program that is hosted within the platform. The platform may then analyze the specific data to determine one or more data contracts that match the data, as described above with respect to block 302 of FIG. 3.

At block 404, in response to user input, a marketplace service may be queried to obtain applications that are compatible with the one or more data contracts. The user input may include, for example, a right click of the user on a particular link or icon hosted by the platform. In some embodiments, the platform may query the marketplace service to obtain a list of recommended applications according to the method described above with respect to block 304 of FIG. 3.

At block 406, an ordered list of the applications may be displayed to the user. In some embodiments, the platform may provide a standard browsing experience to the user via the marketplace service. According to such a browsing experience, the user may view a list of recommended applications. In some embodiments, the user may view the list of recommended applications directly through the platform itself. In other embodiments, the user may leave the platform and navigate in a browser to a Web-based marketplace service. Through the Web-based marketplace service, the user may view various Webpages with recommended applications.

In various embodiments, if the user does not select specific data at block 402, the list of recommended applications may be determined using context-agnostic metadata and may be ordered using a ranking method similar to that described above with respect to block 306 of FIG. 3. For example, the applications may be ranked according to a number of characteristics, including, for example, a user rating for a particular application, an download count for the application, a freshness of the application, a boost rating for the application, a health of the application, and a mutual download count for the application and other applications that the user has already downloaded.

At block 408, an application may be initiated in response to a selection by the user. The application may then be used to view or manipulate the specific data that was selected by the user within the platform.

The process flow diagram of FIG. 4 is not intended to indicate that the steps of the method 400 are to be executed in any particular order, or that all of the steps are to be included in every case. Further, any number of additional steps may be included within the method 400, depending on the specific application.

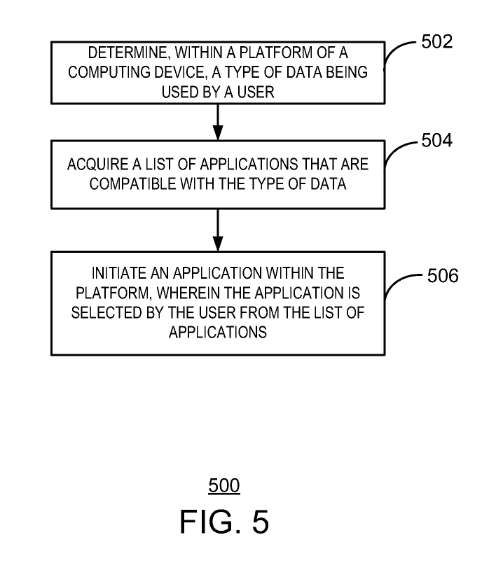

FIG. 5 is a process flow diagram showing a method 500 for application recommendation and substitution. The method begins at block 502 with the determination, within a platform of a computing device, of a type of data being used by a user. The data may be data that is selected by the user of the computing device, or data that is being used by an active application. Determining the type of data being used may include determining a pattern of the data, or determining a data contract that matches the data from a list of data contracts.

In various embodiments, the data contract may be determined based on a number of factors. For example, the data may be analyzed with respect to the known data contracts in order to determine one or more data contracts that match the data. In addition, an active application may be queried to determine which data contract is currently being used. For example, if the application is currently using a text data contract, it may be assumed that the data being utilized by the application is also text. Further, a current document that is running within the application may be examined to determine metadata, e.g., metadata that was included by the developer, identifying the data contracts for various portions of data in the document.

At block 504, a list of applications that are compatible with the type of data being used by the user may be acquired. The applications within the list of applications may include, for example, applications stored within the computing device, applications accessed through a network via the marketplace service, and applications accessed through the network via a third party service. The applications within the list of applications may include a platform identifier that corresponds to the platform and a data contract identifier that corresponds to the type of data.

In some embodiments, the applications within the list of applications may be ranked based on a degree of relevance to the one or more data contracts relating to the data. In addition, the applications within the list of applications may be ordered based on a user rating of each application, a download count of each application, a freshness of each application, a number of times each application has crashed, and a mutual download count for each application and applications that the user has already downloaded, among others. Further, if the data is being used by an active application, the ordering of the applications within the list of applications may also be based on a mutual download count for each application and the active application, a category identifier match between each application and the active application, a switch count between each application and the active application, a skip count corresponding to not choosing each application to replace the active application, a developer identifier match between each application and the active application, and a number of configuration values in each application that match configuration values in the active application, among others.

In various embodiments, the user is able to select any desired application from the marketplace service or third party service, or any desired application that is stored within the computing device. Thus, while the list of applications may be used to aid the user in the selection of an application, the user may manually override such recommendations by selecting an application that is not contained within the list of applications.

At block 506, an application may be initiated within the platform, wherein the application is selected by the user from the list of applications. Once the application has been initiated, the data, as well as configuration data relating to the data, may be inserted into the application. In some instances, the data and/or configuration data cannot be preserved when the application is initiated. In such cases, the user may be warned about the loss of such data, and may be prompted to choose to proceed with the initiation of the application or to cancel the initiation of the application.

In some embodiments, initiating the application includes substituting the application that is selected by the user from the list of applications for the active application. Further, in various embodiments, initiating the application within the platform includes downloading the application from the marketplace service in response to the user clicking on a link within the platform that corresponds to the application. In other embodiments, initiating the application within the platform includes downloading the application from a third party service.

In some embodiments, once the user chooses a desired application, the application is simply pasted on top of another active application according to a pasting procedure. In such instances, the user may be prompted by the computing device to specify if they desire to paste everything, or if they would rather preserve the underlying data and related configuration data during the pasting procedure.

During the initiation of the application, varying amounts of data relating to the previously-active application may be preserved and utilized by the new application. For instance, the size, position, and z-order of the data may be preserved. In addition, any associations with the data inside the document may be preserved. General configuration data for the application may be preserved, such as font style, size, and color, among others. Further, specialized configuration data that is specific to a particular category of applications may be preserved. For example, for comic book applications, the “manga style” may be preserved. In various embodiments, the amount of data that is preserved may be dependent on a level of compatibility of the new application with the previously-active application. For example, in some embodiments, if the two applications are highly compatible, specific application settings of the previously-active application may be duplicated and preserved within the new application.

The process flow diagram of FIG. 5 is not intended to indicate that the steps of the method 500 are to be executed in any particular order, or that all of the steps are to be included in every case. Further, any number of additional steps may be included within the method 500, depending on the specific application. For example, in some embodiments, a preview of an application from the list of applications may be displayed to the user via the platform. The preview may include a representation of the functionality and appearance of the data within the application. Additionally, in instances in which the data and/or configuration data may not be hosted within the application, an icon or flag may be displayed within the preview to warn the user that the application is not fully compatible.

In various embodiments, the application that is initiated within the platform at block 506 is not an application selected from the list of applications but, rather, is an application that is selected from a number of available applications. The available applications may include any types of applications that are compatible with the computing device. Thus, the user may choose to ignore the list of applications that is recommended at block 504 and, instead, activate any of the available applications, regardless of the chosen application's level of compatibility with the type of data being used by the user.

Further, in some embodiments, specific applications are capable of self-declaring particular types of data they can manipulate and particular categories of applications with which they are compatible. For example, an application may declare that it is able to manipulate audio data. This may allow for the extension of the list of applications that is presented to the user at block 504. In some embodiments, an application may specify such conditions within a modified, extended data contract. For example, certain features in any extensible software product, e.g., charting tools or font selectors, can be defined using the same data contract syntax which is published by the software manufacturer. Thus, an alternative implementation of a data contract, i.e., an extended data contract, may be developed by an individual and submitted to the marketplace (if available). The validation pipeline can confirm that the application adheres to the extended data contract. The hosting application can then selectively offer the alternatives specified by the extended data contract, as appropriate. For example, when inserting a chart, an application can suggest different charts that are likely to be compatible. In addition, applications can publish their own extended data contracts, which may provide improvements and alternatives not specified in an original data contract.

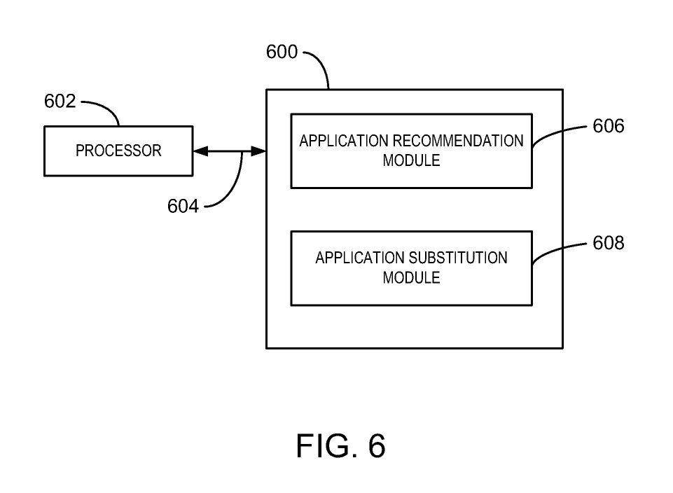

FIG. 6 is a block diagram showing a tangible, non-transitory computer-readable medium 600 that stores code adapted to implement an application recommendation and substitution procedure. The tangible, computer-readable medium 600 may be accessed by a processor 602 over a computer bus 604. Furthermore, the tangible, computer-readable medium 600 may include code configured to direct the processor 602 to perform the steps of the current method.

The various software components discussed herein may be stored on the tangible, computer-readable medium 600, as indicated in FIG. 6. For example, an application recommendation module 606 may be configured to provide a list of recommended applications to a user. The recommended applications may be obtained from a marketplace service or a third party service, for example, and may be ranked based on the ability of each of the applications to deal with a specific type of data that has been selected by a user. Further, an application substitution module 608 may be configured to provide a list of possible substitute applications to a user. The substitute applications may be applications that are capable of dealing with a specific type of data that is being used within an active application. In addition, the application recommendation module 606 and the application substitution module 608 may be configured to activate an application from the list of recommended applications or the list of possible substitute applications, respectively. In the latter case, the previously-active application may be terminated when the selected substitute application is initiated.

It should be noted that the block diagram of FIG. 6 is not intended to indicate that the tangible, computer-readable medium 600 always include the software components 606 and 608. In addition, the tangible, computer-readable medium 600 may include additional software components not shown in FIG. 6.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for application recommendation and substitution, comprising:
analyzing data within a platform of a computing device to determine a pattern of the data;
acquiring a list of applications from a marketplace service, wherein the applications are compatible with the pattern of the data; and
activating an application within the platform, wherein the application is selected in response to an input by a user from the list of applications.

2. The method of claim 1, wherein the data is selected in response to an input by the user of the computing device.

3. The method of claim 1, wherein the data is used by an active application.

4. The method of claim 3, comprising substituting the application that is selected in response to the input by the user from the list of applications for the active application.

5. The method of claim 1, comprising determining the pattern of the data by determining a data contract that matches the data, wherein determining the data contract comprises:
analyzing the data with respect to known data contracts to determine the data contract that matches the data;
querying an active application to determine the data contract that is currently being used by the active application; and
examining a current document that is running within the active application to determine metadata identifying the data contract for the data in the current document.

6. The method of claim 5, wherein the applications are compatible with the data contract that matches the data.

7. The method of claim 1, wherein activating the application within the platform comprises downloading the application from the marketplace service in response to the user clicking on a link within the platform that corresponds to the application.

8. The method of claim 1, comprising activating an application within the platform, wherein the application is selected in response to an input by the user from a plurality of available applications, and wherein the plurality of available applications comprises applications that are compatible with the computing device.

9. The method of claim 1, comprising ordering the applications within the list of applications based on one or more of:
a user rating of each application;
a download count of each application;
a freshness of each application;
a number of times each application has crashed; and
a mutual download count for each application and applications that the user has already downloaded.

10. The method of claim 1, wherein, if the data is being used by an active application, the applications within the list of applications are ordered based on one or more of:
a user rating of each application;
a download count of each application;
a freshness of each application;
a number of times each application has crashed;
a mutual download count for each application and the active application;
a category identifier match between each application and the active application;
a switch count between each application and the active application;
a skip count corresponding to not choosing each application to replace the active application;
a developer identifier match between each application and the active application; and
a number of configuration values in each application that match configuration values in the active application.

11. A system for application recommendation and substitution, comprising a computing device configured to:
determine, within a platform of the computing device, a type of data being used by a user;
acquire a list of applications that are compatible with the type of the data being used by the user; and
initiate an application within the platform, wherein the application is selected from the list of applications in response to an input by the user.

12. The system of claim 11, wherein the data is being used by the user within a document or within an active application, or both.

13. The system of claim 12, wherein the application comprises a substitute application that replaces the active application.

14. The system of claim 11, wherein applications within the list of applications comprise one or more of:
applications stored within the computing device;
applications accessed through a network via a marketplace service; and
applications accessed through the network via a third party service.

15. The system of claim 11, wherein the computing device is configured to display a preview of an application from the list of applications to the user via the platform, and wherein the preview comprises a representation of a functionality and an appearance of the data within the application.

16. The system of claim 11, wherein applications within the list of applications comprise a platform identifier that corresponds to the platform and a data contract identifier that corresponds to the type of data.

17. One or more non-transitory, computer-readable storage media for storing computer-readable instructions, the computer-readable instructions providing an application recommendation and substitution system when executed by one or more processing devices, the computer-readable instructions comprising code configured to:
analyze data to determine one or more data contracts relating to the data;
compile a list of applications comprising applications that are compatible with the one or more data contracts;
initiate an application in response to an input from a user; and
insert the data and configuration data relating to the data into the application.

18. The one or more non-transitory, computer-readable storage media of claim 17, wherein the computer-readable instructions comprise code configured to rank the applications within the list of applications based on a degree of relevance to the one or more data contracts relating to the data.

19. The one or more non-transitory, computer-readable storage media of claim 17, wherein the application comprises a substitute application that replaces a previously-active application.

20. The one or more non-transitory, computer-readable storage media of claim 19, wherein the application preserves an amount of data that was used by the previously-active application, and wherein the amount of data that is preserved is dependent on a level of compatibility of the application with the previously-active application.
